(19) United States
(12) Patent Application Publication
(10) Pub. No.: US 2018/0144839 A1
(43) Pub. Date: May 24, 2018

(54) METHOD FOR ENCAPSULATING RADIOACTIVE WASTE

(71) Applicant: INNOVEOX, Paris (FR)

(72) Inventor: Christian Delavaud, Nantes (FR)

(21) Appl. No.: 15/575,052

(22) PCT Filed: Apr. 7, 2016
(86) PCT No.: PCT/EP2016/057661

§ 371 Date: Nov. 17, 2017

(30) Foreign Application Priority Data
Apr. 17, 2015 (FR) 15 53445

(51) Int. Cl. G21F 9/30; G21F 9/36

(52) U.S. Cl. CPC G21F 9/304; C04B 28/04; G21F 9/36

(57) ABSTRACT

The invention relates to a method for encapsulating radioactive waste, the method comprising the following steps:
mixing dry radioactive waste, water and a binder in a mixer (12) to form a mixture (122),
transferring the mixture (122) from the mixer (12) to an encapsulating unit (20), the mixture (122) being in contact with a transfer surface (84) of a transfer member (22),
producing a test sample comprising dry radioactive waste, water and a binder, and
characterizing the adherence and/or flow of the test sample on the transfer surface (84).

The present invention relates to a method for encapsulating radioactive waste implementing a characterizing step.

Managing radioactive waste contributes to the safety of human health and the environment. To that end, according to one known example, radioactive waste is encapsulated in parcels to confine the radioactivity, while guaranteeing the mechanical and chemical strength of the parcel to ensure safe storage.

Document EP 2,624,257 A2 describes a radioactive waste treatment method comprising the following steps:
mixing cement and radioactive waste in a container by rotating an agitating blade at a rotation speed comprised within a predetermined interval,
monitoring a value of a control current for controlling the agitating blade during mixing,
obtaining a product mixed with cement including radioactive waste and cement by mixing until the monitored value of the control current begins to increase by a given value, and
solidifying the mixed product with cement to manufacture a solidified product with cement.

However, it is difficult to choose a composition of the product mixed with cement and waste compatible with the performance requirements of the treatment method.

To that end, proposed is a method for encapsulating radioactive waste, the method comprising the following steps:
mixing dry radioactive waste, water and a binder in a mixer to form a mixture,
transferring the mixture from the mixer to an encapsulating unit, the mixture being in contact with a transfer surface of a transfer member,
producing a test sample comprising dry radioactive waste, water and a binder, and
characterizing the adherence and/or flow of the test sample on the transfer surface.

According to specific embodiments of the invention, the encapsulating method has one or more of the following features, considered alone or according to any technically possible combination(s):
the mixing and the production of the test sample are two separate steps,
the method further comprises a selection step, the test sample being selected if the test sample fulfills one or more given criteria, a composition of the mixture being selected owing to the characterizing step,
if no test sample is selected in the selection step, the steps for producing a test sample and characterizing the adherence and/or flow of the test sample on the transfer surface are reiterated,
the given criteria are at least one of the following criteria:
   a test sample residue mass during the characterizing step is below 10 grams per 100 square centimeters (cm²) of transfer surface, or more particularly below 7 grams for 100 square centimeters (cm²) of transfer surface,
   a duration representative of the flow is below 200 seconds, and
   a flow rate equivalent to the displacement of at least 100 millimeters (mm) with a mass greater than 50 kilograms (kg) of mixture per hour,
the method further comprises a step for vibrating the mixture using at least one vibrating needle having a main axis, the vibrating needle including a weight that is off-centered relative to the main axis rotating at a predetermined frequency,
during the step for vibrating the mixture, the predetermined frequency is comprised between 10,000 revolutions per minute and 20,000 revolutions per minute,
the method further comprises a step for observing a release of air from the mixture, the step for vibrating the mixture being stopped when a release of air from the mixture ceases to be observed,
the method further comprises a step for determining the density of the mixture,
one or several of the following characteristics are verified:
   the transfer surface includes at least two layers, one of the layers being a coating made up of at least 95% natural rubber,
   the transfer surface has a slope with an incline comprised between 8° and 20°,
   the method further comprises a step for percussion of the transfer surface,
   the method further comprises a step for mechanically vibrating the transfer surface, and
   the method comprises a step for moistening the transfer surface before the step for characterizing the adherence and/or flow of the test sample on the transfer surface,
the method further comprises a step for detecting the presence of setting inhibitors, for example zinc, in the test sample,
the radioactive waste of the test sample consists of a mixture of clinker and ash, the weight percentage of clinker in the mixture being comprised between 0.7 and 0.8,
the test sample has at least one of the following features:
   a water content level comprised between 10 and 35 liters per cubic meter (L.m⁻³),
   a weight ratio of radioactive waste to binder comprised between 2.5 and 3, and
   a weight ratio of water to binder comprised between 0.77 and 0.97, and
the test sample further comprises a plasticizer.

Other features and advantages of the invention will appear upon reading the following description of embodiments of the invention, provided as an example only and in reference to the drawings, which are:

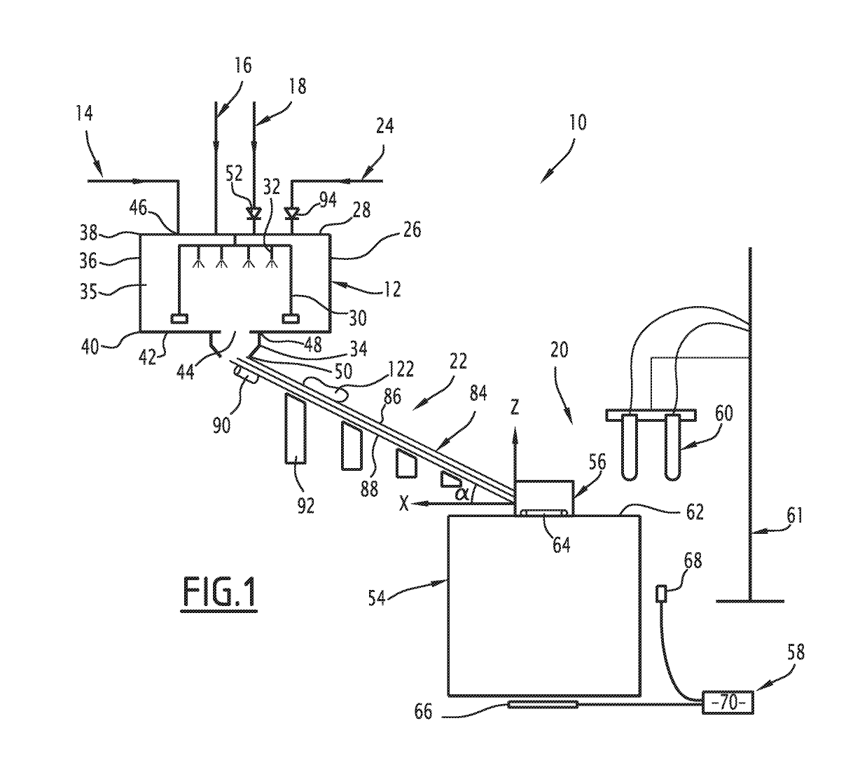

FIG. 1, a schematic view of a device making it possible to carry out an example method for encapsulating radioactive waste,

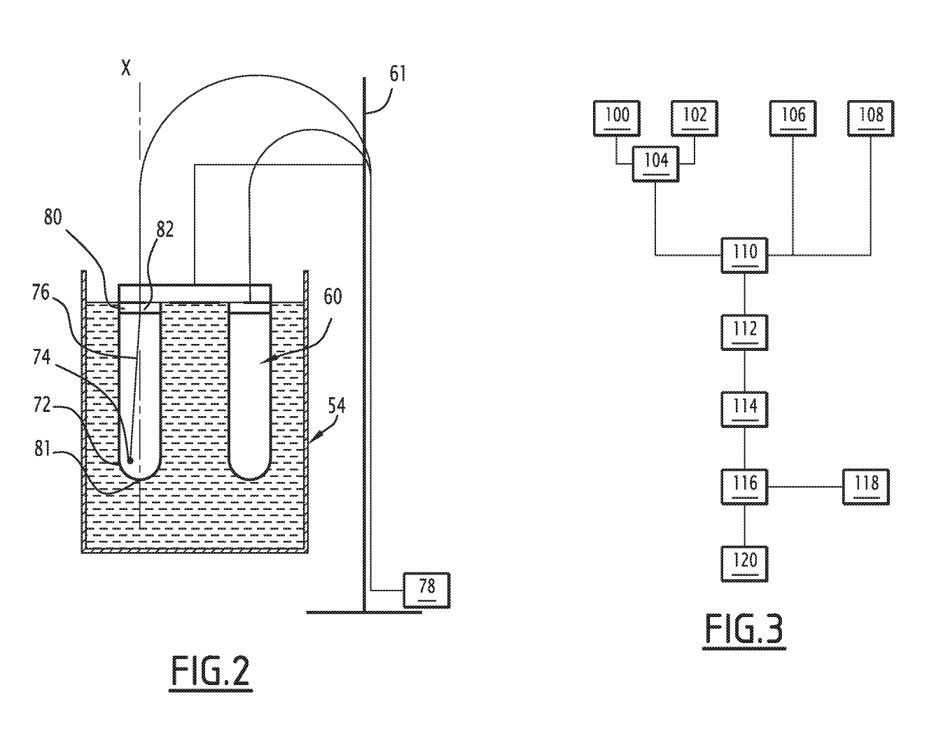

FIG. 2, a schematic view of a part of the device of FIG. 1 making it possible to carry out a step for vibrating a mixture,

FIG. 3, a flowchart of an example embodiment of a method for encapsulating radioactive waste, and

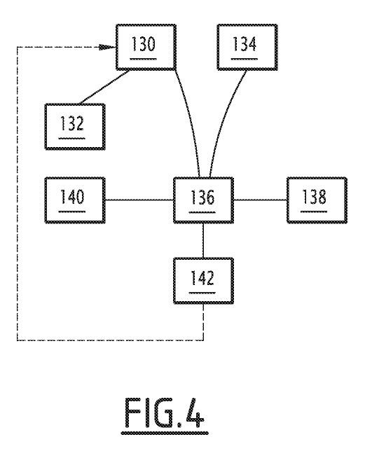

FIG. 4, a flowchart of an example embodiment of a step for characterizing the behavior of a transfer member.

A device 10 able to carry out an example method for encapsulating radioactive waste is shown in FIG. 1.

The device 10 comprises a mixer 12, an intake member for radioactive waste 14, an intake member for a binder 16, a water intake 18, a encapsulating unit 20 and a transfer member 22. According to the example of FIG. 1, the device 10 further comprises at least one intake 24 for one or several chemical additives.

The mixer 12 is able to mix a set of substances to obtain a mixture.

In the described example, the mixer 12 comprises a vat 26, a cover 28, at least one mixing member 30, a cleaning member 32 and an outlet neck 34.

The vat 26 defines an inner volume 35.

The vat 26 is able to store all of the substances to be mixed, then the mixture, in the inner volume 35.

The vat 26 for example comprises a side wall 36 defining an upper end 38 and a lower end 40 for the vat 26, and a bottom 42. The bottom 42 is connected to the side wall 36 at the lower end 40.

The side wall 36 is cylindrical with a circular base.

The bottom 42 has a circular shape with the same radius as the cylinder formed by the side wall 36.

The bottom 42 is provided with at least one opening provided to accommodate a sensor monitoring the hygrometry of the substance within the vat 26.

The bottom 42 also defines an orifice 44. The orifice 44 is able to allow a substance to leave the vat 26 toward the outlet neck 34.

The orifice 44 is an orifice in contact with the side wall 36.

Alternatively, the orifice 44 is a central orifice.

The vat 26 is for example made from stainless steel.

The cover 28 is able to close the vat 26 at the upper end 38 of the vat 26.

The cover 28 is a disc larger than or equal to the size of the base circle of the side wall 36.

The cover 28 forms a single piece with the side wall 36 or rests on the side wall 36 at the upper end 38.

The cover 28 is also configured to accommodate the material intakes in the vat 26.

The cover 28 defines at least three holes 46. The holes 46 delimited by the cover 28 are connected to the intake member for radioactive waste 14, the intake member for a binder 16 and the water intake 18.

The cover 28 and the vat 26 are made from the same material. According to the example of FIG. 1, the cover 28 is made from stainless steel.

The mixing member 30 is able to mix a substance located in the inner volume 35 of the vat 26.

The mixing member 30 is arranged inside the inner volume 35 of the vat 26.

The mixing member 30 is mounted on the cover 28.

The mixing member 30 is able to be rotated by a motor.

The mixing member 30 is for example planetary rotating blades. The planetary rotating blades make up a member comprising several arms provided with scrapers. The arms of the planetary rotating blades are elongated between the cover 28 and the bottom 42 of the vat 26.

The mixing member 30 is also made from stainless steel.

The mixing member 30 is covered by a coating made up of at least 95% natural rubber. Natural rubber is a linear polymer called cis-1,4-polyisoprene with formula (C₅H₈)ₙ.

The cleaning member 32 is configured to splash the inner volume 35 of the vat 26 with a liquid.

The cleaning member 32 is able to splash the side wall 36 of the vat 26, the bottom 42 and the cover 28.

The cleaning member 32 is for example a set of nozzles mounted on the mixing member 26. The nozzles are oriented toward the side wall 36 of the vat 26, the bottom 42 and the cover 28. The nozzles sweep the inner volume 35, when the planetary rotating blades are rotated.

The outlet neck 34 is able to prevent a substance from leaving the vat 26, or to allow it to do so.

The outlet neck 34 extends between two ends.

The outlet neck 34 defines, at a first end, an upper opening 48, and at a second end, a lower opening 50.

At the upper opening 48, the outlet neck 34 is connected to the bottom 42 of the vat 26 at the orifice 44.

The outlet neck 34 has at least two positions: an open position and a closed position. When the outlet neck 34 is in the closed position, the outlet neck 34 prevents any substance contained in the vat 26 from leaving it. When the outlet neck 34 is in the open position, the outlet neck 34 is an outlet from the vat 26.

The outlet neck 34 is for example made from stainless steel.

The intake member for radioactive waste 14 is able to bring radioactive waste toward the mixer 12. The intake member for radioactive waste 14 and the mixer 12 are configured so that the radioactive waste is poured into the inner volume 35 of the vat 26.

The intake member for radioactive waste 14 is able to measure the quantity of radioactive waste poured into the inner volume 35 of the vat 26 and to stop pouring radioactive waste when a predetermined quantity is reached.

The waste intake member 14 is elongated between two ends.

A first end is connected to a radioactive waste storage area and a second end is connected to one of the holes 46 defined in the cover 28.

The first end of the waste intake member 14 has at least one open position, making it possible to allow the radioactive waste to pass from the storage area to the waste intake member 14, and a closed position, preventing the passage of the radioactive waste.

In the described example, the radioactive waste intake member 14 is one or several handling screws placed end to end. Each handling screw comprises a cradle defining the inner volume and a coreless screw able to rotate in the inner volume of the cradle. Each handling screw is provided with a device for measuring the mass of material contained in the inner volume of the cradle.

The intake member for a binder 16 is able to bring a binder toward the mixer 12. The intake member for a binder 16 and the mixer 12 are configured so that the binder is poured into the inner volume 35 of the vat 26.

The intake member for the binder 16 is able to measure the quantity of binder poured into the inner volume 35 of the vat 26 and to stop pouring binder when a predetermined quantity is reached.

In the described example, the intake member for a binder 16 is similar to the waste intake member 14, with the exception of the following differences. The first end of the intake member for a binder 16 is connected to a binder storage area. The second end of the intake member for a binder 16 is connected to one of the holes 46 defined in the cover different from the hole, to which the intake member for radioactive waste 14 is connected.

The water intake 18 is able to pour water into the inner volume 35 of the vat 26. The water intake 18 is configured to measure the quantity of water poured into the inner volume 35 of the vat 26 and to stop pouring water when a predetermined quantity is reached.

The water intake 18 is for example a hose with two ends. At a first end, the water intake 18 is connected to a water distribution system. At the other end, the water intake 18 is connected to one of the holes 46 defined in the cover 24 of the mixer 12. The water intake 18 is configured so that the water circulates from the end connected to a water distribution system to the end connected to the mixer 12.

The water intake 18 comprises a water retaining member 52. The water retaining member has at least an open position, able to allow the water to circulate in the water intake, and a closed position, able to prevent the water from circulating in the water intake 18. The water retaining member 52 is a non-return valve situated between the two ends of the hose. A system makes it possible to measure the quantity of water that the water retaining member 52 has allowed to pass.

The encapsulating unit 20 comprises at least a container 54, a filling unit 56, a measuring device 58, at least one vibrating needle 60 shown in FIG. 2 and a support 61.

The container 54 is configured to store a substance comprising radioactive waste.

In the described example, the container 54 assumes the form of a cylinder having, as base line, a vertical axis, and as base, a disc having a radius. The container 54 defines an inner volume.

The container 54 is made from a material including concrete or metal, for example alloyed steel.

The container 54 contains between 100 and 1000 liters.

The filling unit 56 is able to pour a substance into the container 54.

The filling unit 56 comprises a cap 62 provided with a valve 64.

In the described example, the cap 62 is a disc with a radius larger than the radius of the container 54.

The cap 62 delimits an orifice.

The cap 62 is able to be moved between two positions: a filling position and an idle position.

In the filling position, the cap 62 rests on the upper end of the container 54, so that the cap 62 covers the container 54.

In the idle position, the cap no longer rests on the container 54 and is moved away from the container 54. In the idle position, the inner volume of the container 54 is then accessible by its upper end.

The valve 64 is situated at the orifice defined by the cap 62. The valve 64 has at least two positions: a closed position and an open position.

When the valve 64 is closed and the cap 62 is in the filling position, the cap 62 hermetically seals the container 54. When the valve 64 is open and the cap 62 is in the filling position, a substance can be introduced into the container 54 by the valve 64.

The filling unit 56 is for example made from stainless steel.

The measuring device 58 is configured to measure the filling of the container 54 by volume and by mass.

The measuring device 58 comprises a scale 66, a laser metrology device 68 and a computer 70.

The scale 66 is able to measure the mass of any substance comprised in the inner volume of the container 54.

The laser metrology device 68 is able to measure the filling height of the container 54. The laser metrology device 68 is configured to read the inside of the container 54.

The computer 70 is able to compute the density of any substance comprised in the inner volume of the container 54. The computer 70 is connected to the scale 66 and the laser metrology device 68. The computer 70 receives, as input, the mass measured by the scale 66 and the height measured by the laser metrology device 68.

The vibrating needle 60 is configured to generate vibrations.

The vibrating needle 60, shown in FIGS. 1 and 2, comprises a body 72, a weight 74, a rotating system 76 and an outside connector 78.

The body 72 is substantially in the form of a closed rigid tube elongated along the main axis X. The body 72 defines an inner volume.

The vibrating needle 60 extends primarily along the main axis X of the body 72.

The body 72 has two ends 80, 81.

At one end 80, the body 72 comprises a connecting system 82. The connecting system 82 allows the connection of the outside connector 78 to the body 72 of the vibrating needle 60.

The body 72 is made from a material comprising stainless steel.

The weight 74 is situated in the inner volume of the body 72.

The weight 74 is off-centered relative to the main axis X of the body 72 of the vibrating needle 60.

The center of gravity of the weight 74 is not situated on the main axis X of the body 72 of the vibrating needle 60.

The weight 74 is able to be rotated by the rotating system 76.

The rotation of the weight 74 occurs around the main axis X of the body 72 of the vibrating needle 60.

The rotation of the weight 74 is implemented at a predetermined frequency.

The rotating system 76 is for example a rod connecting the weight 74 to the connecting system 82.

The rod is able to be rotated around the axis X by a motor.

Alternatively, the rotating system 76 is a rotor of a motor along the axis X on which the weight 74 or another compressed air system is mounted establishing a stream of air able to rotate the weight 74 around the axis X.

The outside connector 78 is able to activate the rotating system 76.

The outside connector 78 of the vibrating needle 60 is situated outside the inner volume of the body 72.

The outside connector 78 is connected to the body 72 of the vibrating needle 60 at the connecting system 82.

Depending on the nature of the rotating system 76, the outside connector 78 is a motor, an electric motor or a compressed air system. The connecting system 82 is then a driving device, a power outlet or an opening defined by the body 72.

The support 61 is configured to maintain the vibrating needle 60.

The support 61 is able to move the vibrating needle(s) 60 between at least two positions: an idle position, in which the vibrating needle 60 is not in the inner volume of the container 54 and the vibrating needle 60 does not prevent the cap 62 from closing the container 54, and a vibrating position, in which the vibrating needle 60 is at least partially in the inner volume of the container 54 when the cap 62 is in the idle position. When the vibrating needle 60 is in the vibrating position, the cap 62 is in the idle position.

The support 61 is commanded automatically or manually.

The support 61 is for example made from stainless steel.

The transfer member 22 is configured to transfer a substance from the mixer 12 to the encapsulating unit 20.

The transfer member 22 connects the mixer 12 to the encapsulating unit 20.

In particular, the transfer member 22 comprises two ends. A first end is connected to the outlet neck 34 of the mixer 12. A second end is connected to the filling unit 56 of the encapsulating unit 20.

In the described example, the transfer member 22 is a pouring channel.

The transfer member 22 has a transfer surface 84. The transfer surface 84 is able to be in contact with a substance leaving the mixer 12.

The transfer surface 84 has a slope. In the case at hand, the slope is linear. The transfer surface 84 forms an angle α, called incline angle, with any horizontal plane. The angle α is comprised between 8° and 20°. The expression “comprised” means on the one hand that the angle α is greater than or equal to 8° and on the other hand that the angle α is less than or equal to 20°.

The vertical of the location is defined by a vertical axis Z at the second end of the transfer member 22, connected to the filling unit 56. There is a horizontal axis X perpendicular to the axis Z and passing through the second end of the transfer member 22, connected to the filling unit 56, so that the vertical plane containing the horizontal axis X has a nonzero intersection with the pouring channel. The angle α is the angle between the axis X and the slope of the transfer surface 84.

In another embodiment, the transfer surface 84 is such that, at any point of the transfer surface 84, a plane tangent to the transfer surface 84 forms an angle comprised between 8 and 20° with the horizontal plane.

The transfer surface 84 includes at least two layers 86 and 88.

One of the layers 86 is a coating made up of at least 95% natural rubber.

The transfer member 22 comprises at least one vibrating member 90 and/or percussion system 92.

The vibrating member 90 is configured to vibrate the transfer surface 84. The vibrating member 90 is in contact with the transfer surface 84.

The percussion system 92 is configured to strike the transfer surface 84. The percussion system 92 for example comprises several percussive members able to strike the transfer surface 84 at several points.

In one embodiment, the transfer member 22 comprises a device for washing the transfer surface 84.

The chemical additive intake 24 is able to pour a chemical additive into the inner volume 35 of the vat 26. The chemical additive 24 is configured to measure the quantity of chemical additive poured and to stop pouring chemical additive when a predetermined quantity is reached.

The chemical additive intake 24 is for example similar to the water intake 18, with the exception of the following difference. At one end, the chemical additive intake 24 is connected to a chemical additive storage vat, and not to a water distribution system.

The chemical additive intake 24 comprises a chemical additive retaining member 94, similar to the water retaining member 52 of the water intake 18.

An example method for encapsulating radioactive waste will now be described, in light of FIG. 3. The encapsulating method is for example carried out by the device 10 previously described.

In the described example, the radioactive waste, the binder and the additive will now be described.

Radioactive waste is a material for which no use is anticipated and that contains radio-nucleotides in concentrations higher than the values considered acceptable by the competent authorities in materials suitable for unsupervised use.

The encapsulation method applies to a substance having an activity greater than one hundred becquerels per gram and a half-life exceeding 100 days.

In the described example, the radioactive waste is dry radioactive waste, such as ash, clinker and dust with a density below 1.7.

Clinker is solid residue from the combustion of coal. Ash is solid residue from the combustion of organic matter, i.e., one of the component chemical elements of which is the element carbon.

The binder is a composite Portland cement, comprising at least 65% clinker.

Alternatively, the binder is an aluminous cement, comprising clinker and calcium aluminates.

One (or several) additive(s) is (are) a plasticizer.

A plasticizer is a substance added to formulations of different types of materials to make the materials more flexible, stronger, more resilient and/or easier to manipulate.

In the described example, the plasticizer has a base of modified polycarboxylate and phosphonate or modified polycarboxylate.

Among the additive(s) present, preferably at least one is a fluidifier, a retarder or an air eliminator.

A fluidifier improves the final mechanical strength of the mixture comprising it.

A retarder delays the setting of a mixture comprising it.

An air eliminator facilitates the expulsion of air within the mixture.

The method comprises the following steps:
a step for conveying radioactive waste 100,
a step for conveying binder 102,
a first mixing step 104,
a step for conveying water 106,
a step for conveying additive 108,
a second mixing step 110,
a transfer step 112,
a filling step 114,
a vibrating step 116,
a step for observing a release of gas 118, and
a step for closing the container 120.

The step for conveying radioactive waste 100 consists of conveying a predetermined quantity of radioactive waste in the mixer 12.

The step for conveying radioactive waste 100 is carried out by the intake member for radioactive waste 14.

At the beginning of the step for conveying radioactive waste 100, the outlet neck 34 of the mixer 12 is in the closed position. The water retaining member 52 and the chemical additive retaining member 94 are in the closed position. The waste intake member 14 is not active.

According to one embodiment, in parallel, a step for detecting radioactive waste in a detection volume takes place. The detection volume is comprised in the inner volume of the cradle. The detection volume is for example the set of points situated at least a certain distance from the end of the waste intake member 14 connected to the mixer 12. The aforementioned distance is for example midway from the ends of the waste intake member 14. If radioactive waste is detected in the detection volume from the beginning of the step for conveying radioactive waste 100, the first end of the waste intake member 14 is placed in the closed position.

If no radioactive waste is detected in the detection volume at the beginning of the step for conveying radioactive waste 100, the first end of the waste intake member 14 is open. The intake member for radioactive waste 14 is activated. The coreless screw begins to rotate in the inner volume of the cradle. Radioactive waste is moved, by the waste intake member 14, in a direction going from the radioactive waste storage area toward the mixer 12. When radioactive waste is detected in the detection volume, the first end of the waste intake member 14 is placed in the closed position. The intake member for radioactive waste 14 is deactivated.

A quantity of radioactive waste is contained in the inner volume of the cradle. The filling of the inner volume of the cradle is comprised between 30% and a determined rate greater than 50%.

A mass representative of the mass of the quantity of waste contained in the inner volume of the cradle is measured. The mass is for example the mass of the quantity of radioactive waste contained in the inner volume of the cradle or the mass of the cradle and the radioactive waste. The value of the mass is then equal to an initial value.

The intake member for radioactive waste 14 is activated, so that the radioactive waste in the inner volume of the intake member for radioactive waste 14 moves toward the mixer 12. The radioactive waste having reached the second end of the waste intake member is poured into the vat 26 of the mixer 12 through one of the holes 46 of the cover 28.

The mass previously measured is monitored. The mass measured above is measured continuously or regularly, i.e., at time intervals strictly shorter than 15 ms.

The quantity of radioactive waste poured into the mixer 12 at a given moment is calculated by subtracting the initial value of the mass and the value of the mass measured at this given moment.

The intake member 14 for radioactive waste is stopped when the quantity of radioactive waste poured into the mixer 12 reaches a predetermined value. The step for conveying radioactive waste 100 is complete.

Alternatively, the radioactive waste intake member 14 is not deactivated upon measuring the initial mass.

In another embodiment, the radioactive waste intake member 14 is activated, then deactivated at regular intervals. Upon each deactivation of the radioactive waste intake member 14, the mass is measured and the quantity of radioactive waste poured into the mixer 12 is calculated. If the quantity of radioactive waste poured into the mixer 12 is greater than or equal to the predetermined value, then the radioactive waste intake member 14 is not reactivated and the step for conveying radioactive waste 100 is complete.

At the end of the step for conveying radioactive waste 100, the inner volume 35 of the vat 26 of the mixer 12 contains a predetermined quantity of radioactive waste.

The step for conveying binder 102 consists of conveying a predetermined quantity of binder in the mixer 12.

The step for conveying binder 102 is carried out by the binder intake member 16.

At the beginning of the step for conveying binder 102, the outlet neck 34 of the mixer 12 is in the closed position. The water retaining member 52 and the chemical additive retaining member 94 are in the closed position. The binder intake member 16 is not active.

According to one embodiment, the step for conveying binder 102 is carried out similarly to the step for conveying radioactive waste 100, with the exception of the fact that the step is implemented by the binder intake member 16, and not the radioactive waste intake member 14.

At the end of the step for conveying binder 102, the inner volume 35 of the vat 26 of the mixer 12 contains a predetermined quantity of binder.

The steps for conveying radioactive waste 100 and binder 102 take place in parallel or one after the other.

The first mixing step 104 consists of mixing the radioactive waste and the binder in the inner volume 35 of the vat 26 of the mixer.

The first mixing step 104 takes place after the steps for conveying radioactive waste 100 and binder 102. The first mixing step 104 takes place in the inner volume 35 of the vat 26 of the mixer 12 with the mixing member 30.

At the beginning of the first mixing step 104, the inner volume 35 of the vat 26 of the mixer 12 contains radioactive waste and binder. The water retaining member 52 and the chemical additive retaining member 94 are in the closed position. The outlet neck 34 of the mixer 12 is in the closed position. The intake members for radioactive waste 14 and binder 16 are deactivated.

The mixing member 30 is activated. The mixing member 30 mixes the radioactive waste and the binder in the inner volume 35 of the vat, i.e., the mixing member 30 stirs the radioactive waste and the binder together.

The mixing of the radioactive waste and the binder is done for a predetermined length of time, comprised between 2 and 4 minutes, and/or until a criterion is satisfied.

The criterion is for example that the intensity of the supply current of the motor of the mixing member 30 reaches a constant value to within 5%.

In one embodiment, the mixing member 30 is provided to rotate at a given speed. The intensity of the supply current of the motor is representative of the resistance of the mixture relative to the mixing member 30.

At the end of the first mixing step 104, the inner volume 35 of the vat 26 comprises a prior mixture of radioactive waste and binder.

The step for conveying water 106 consists of conveying a predetermined quantity of water to the inside of the inner volume 35 of the vat 26 of the mixer 12.

At the beginning of the step for conveying water 106, the outlet neck 34 of the mixer 12 is in the closed position and the inner volume of the vat comprises a prior mixture of radioactive waste and binder. The water retaining member 52 is in the closed position.

The step for conveying water 106 takes place after the first mixing step 104. The step for conveying water 106 is carried out by the water intake 18.

The water retaining member 52 is placed in the open position. Water is then poured through the water intake 18 into the inner volume 35 of the vat 26 of the mixer 12. The quantity of water passing the water retaining member 52 is measured by the system making it possible to measure the quantity of water having passed the device.

When the quantity of water having passed the water retaining member 52 reaches the predetermined value, the water retaining member 52 is placed in the closed position.

The water having passed the water retaining member 52 arrives in the inner volume 35 of the vat 26 of the mixer 12 during the step for conveying water 106.

At the end of the step for conveying water 106, the inner volume 35 of the vat 26 comprises a predetermined quantity of water and the prior mixture of radioactive waste and binder.

The step for conveying additive 108 consists of conveying a predetermined quantity of one or several additives to the inside of the inner volume 35 of the vat 26 of the mixer 12.

At the beginning of the step for conveying additive 108, the outlet neck 34 of the mixer 12 is in the closed position and the inner volume of the vat comprises a prior mixture of radioactive waste and binder. The chemical additive retaining member 94 is in the closed position.

The step for conveying additive 108 for example takes place after the first mixing step 104. The step for conveying additive 108 is carried out by the additive intake(s) 24.

The step is described for one additive intake 24.

If the predetermined quantity is equal to a zero value, then the step for conveying additive 108 is complete.

If the predetermined quantity is different from the zero value, the step for conveying additive 108 is carried out similarly to the step for conveying water 106, with the exception of the fact that the step for conveying additive 108 is implemented by the additive intake 26 and the additive retaining member 94.

If the device 10 comprises several additive intakes 24, then the step is repeated for each additive intake 24. The steps for each additive intake 24 can take place at the same time or one after another.

At the end of the step for conveying additive, the inner volume 35 of the vat 26 comprises a predetermined quantity of the additive(s) and the prior mixture of radioactive waste and binder.

The second mixing step 110 consists of mixing the prior mixture of radioactive waste and binder, water and any additives to form a mixture 122.

The second mixing step 110 takes place after the steps for conveying water 106 and additive 108. The second mixing step 110 takes place in the inner volume 35 of the vat 26 of the mixer 12 with the mixing member 30.

At the beginning of the second mixing step 110, inner volume 35 of the vat 26 of the mixer contains water, the prior mixture of radioactive waste and binder, and optionally one or several additives. The water retaining member 52 and the chemical additive retaining member 94 are in the closed position. The intake members for radioactive waste 14 and binder 16 are deactivated. The outlet neck 34 of the mixer 12 is in the closed position.

The mixing member 30 is activated. The mixing member 30 mixes the water, the prior mixture of radioactive waste and binder, and the chemical additive in the inner volume 35 of the vat 26. The mixing member 30 stirs the water, the prior mixture of radioactive waste and binder, and the chemical additive together, to form the mixture 122.

The mixing of the water, the prior mixture of radioactive waste and binder, and chemical additive, is done for a predetermined length of time, comprised between 4 and 6 minutes, and/or until a criterion is satisfied.

The criterion is for example that the intensity of the supply current of the motor of the mixing member 30 reaches a constant value to within 5%.

In one embodiment, the sensor at the bottom 42 of the vat 26 monitors the hygrometry of the mixture within the vat 26. If the hygrometry of the mixture is too low, water is added through the water intake 18. This in particular makes it possible to increase the plasticity of the mixture.

The plasticity of the mixture is in particular calculated from the intensity of the supply current of the motor of the mixing member 30.

At the end of the second mixing step 110, the inner volume 35 of the vat 26 comprises a prior mixture 122 of radioactive waste, binder, water and possible additive.

The transfer step 112 consists of transferring the mixture 122 from the mixer 12 to the encapsulating unit 20.

The transfer step 112 is carried out by the outlet neck 34 and the transfer member 22. The transfer step 112 takes place after the mixing step 110.

At the beginning of the transfer step 112, the outlet neck 34 is in the closed position. The water retaining member 52 and the chemical additive retaining member 94 are in the closed position. The intake members for radioactive waste 14 and binder 16 are deactivated. The cap 62 of the filling unit 56 is in the filling position. The valve 64 of the filling unit 56 is in the closed position. The inner volume 35 of the vat 26 comprises the mixture 122 of radioactive waste, binder, water and possible additive.

The transfer surface 84 is moistened. In the described example, the moistening is done by the system for washing the transfer surface 84. The system for washing the transfer surface 84 splashes water on the transfer surface 84. The water flows on the transfer surface, outside residual moistening. The residual moistening for example corresponds to a water mass comprised between 100 g and 150 g for 1 m² of transfer surface 84.

The outlet neck 34 of the mixer 12 is placed in the open position. The mixture 122 of radioactive waste, binder, water and possible additive leaves the vat 26 through the outlet neck 34.

The mixture 122 of radioactive waste, binder, water and possible additive is able to flow to the transfer member 22. The mixture 122 of radioactive waste, binder, water and possible additive comes into contact with the transfer surface 84 of the transfer member 22, and more particularly with the coating 86 made up of at least 95% natural rubber.

The vibrating member 90 is activated. The vibrating member 90 mechanically vibrates the transfer surface 84.

The coating of the transfer surface is subject to the mechanical vibration. The coating begins to oscillate. The coating has a return to an initial position, owing to shape memory of the coating of the transfer surface. The mixture 122 is able to flow in contact with the transfer surface 84, for example on the transfer surface. The mixture 122 flows to the filling unit 56 of the encapsulating unit 20.

Residue of the mixture 122 remains in contact with the transfer surface 84 and does not reach the encapsulating unit 20. The mixture residue represents less than 10 grams per 100 cm² of transfer surface 84, and preferably less than 7 grams for 100 cm² of surface.

Alternatively, the percussion system 92 of the transfer surface 84 is activated. Thus, the transfer surface 84 is struck by the percussion system 92. The percussive members of the percussion system 89 strike the transfer surface 84 at a given frequency. The frequency is comprised between 1500 Hz and 3000 Hz. The force applied by the percussion system 92 on the transfer surface is comprised between 700 N and 900 N, and more particularly equal to 800 N to within 5%.

In another embodiment, the vibrating member 90 and the percussion system 92 are activated.

At the end of the transfer step 112, the mixture 122 is primarily situated at the filling unit 56 at the valve 64 in the closed position. Residue of the mixture is in contact with the transfer surface 84. The mixture 122 excluding residue is subsequently called the mixture 122.

Alternatively, the valve 64 of the filling unit 56 is in the open position.

The filling step 114 consists of filling the container 54 with the mixture 122.

The filling step 114 is carried out by the filling unit 56 and the measuring device 58.

At the beginning of the filling step 114, the cap 62 is in the filling position. The mixture 122 is at the filling unit 56. The mixture 122 is not in the container. The filling step 114 takes place after the transfer step.

At the beginning of the filling step 114, the scale 66 is tared.

If the valve 64 of the filling unit is in the closed position, the valve 64 is placed in the open position. If not, the valve 64 remains in the open position.

The mixture 122 enters the inner volume of the container 54 through the valve 64.

When the mass calculated by the scale 66 no longer increases and/or when the mixture 122 has visually fully entered the inner volume of the container 54, the scale 66 reads the mass of mixture introduced into the container 54 and the laser metrology device 68 reads the filling height of the container 54. The computer 70 then calculates the density of the mixture 122 contained in the container 54. Information concurrent with a regulatory filling of the container 54 is obtained.

Alternatively, in parallel with the filling step 114, a step for monitoring the mass measured by the scale 66 is started. When the mass measured by the scale 66 reaches a given value, the valve 64 is closed. The density of the mixture 122 contained in the container 54 is then calculated.

At the end of the filling step 114, the mixture 122 is in the inner volume of the container 54.

The vibrating step 116 consists of applying a strong internal vibration to the mixture 122 within the container 54. The vibrating step 116 is provided to increase the compactness of the mixture 122. A larger quantity of mixture 122, therefore radioactive waste, is able to be stored in the container 54.

At the beginning of the vibrating step 116, the container 54 is filled with the mixture 122. The cap 62 is in the filling position.

The vibrating step 116 takes place after the filling step 114.

The cap 62 is moved into the idle position. Then, the support 61 moves the vibrating needle(s) 60 into the vibrating position. The vibrating needle(s) 60 are then at least partially submerged in the mixture 122 in the inner volume of the container 54. The vibrating needle 60 is such that its main axis X is parallel to the vertical of the location, therefore the main axis of the container 54.

The rotating system 76 is activated. The weight 74 is rotated around the main axis X by the vibrating needle 91 at a given frequency, for example comprised between 10,000 revolutions per minute and 20,000 revolutions per minute.

The activation of each vibrating needle 60 causes a vibration of the mixture 122 in the container 54, i.e., a strong internal vibration of the mixture. This increases the compactness of the mixture. The mixture then assumes a more compact arrangement. The smaller elements of the mixture are placed between the larger elements.

In one embodiment, the support 61 moves the vibrating needle 60 within the mixture 122. This embodiment in particular corresponds to the case where there is no longer an immobile configuration of the vibrating needle(s), in which the vibrating needle(s) are able to vibrate the entire mixture.

The step for observing a release of gas 118 consists of observing the presence or absence of a release of gas during the vibrating step 116.

The observation step 118 takes place at the same time as the vibrating step 116.

A release of gas from the mixture 122 in the inner volume of the container 54 is observed. The observation is done via a camera by a computer making it possible to process the images and/or a viewer. The release of gas is for example visible to the naked eye, for example the release of gas is turbulent relative to the air.

In another embodiment, the release of gas is visible by a decrease in the height of the mixture contained in the container 54. The decrease in the height is observed by the laser metrology device 68.

When a release of air from the mixture 122 ceases to be observed, the vibrating needle 60 is deactivated. The support 61 moves each vibrating needle 60 into the idle position. The step 116 for vibrating the mixture 122 and the step for observing a release of gas 118 end.

The density of the mixture 122 in the container 54 is modified by the vibrating step 116. A new measurement of the filling of the container 54 is done by the laser metrology device 68. The density is then recalculated by the computer 70.

Alternatively, the new density is estimated from the density of the mixture before the vibrating step 116 of the mixture 122. The density of the mixture before the vibrating step 116 of the mixture 122 is for example comprised between 1.27 kg/m³ and 1.7 kg/m³.

For a mixture 122 in which the radioactive waste consists of a mixture of clinker and ash, in which the density in clinker is substantially equal to 0.7, the density is multiplied by 1.27.

For a mixture 122 in which the radioactive waste consists of a mixture of clinker and ash, in which the density in clinker is substantially equal to 0.8, the density is multiplied by a factor comprised between 1.11 and 1.20.

At the end of the vibrating step 116, the inner volume of the container 54 comprises the mixture 122. The mixture 122 is more compact than before the vibrating step 116. The density of the mixture 122 has increased during the vibrating step 116.

The step for closing the container 120 consists of placing a cover on the container 54.

At the beginning of the step for closing the container 120, the mixture 122 is in the inner volume of the container 54. The step for closing the container 120 takes place after the vibrating step 116 and the step for observing a release of gas 118.

The cover is a disc with a radius that is the radius of the container 54. In the described example, the cover is placed on the container 54 using a crane. The cover nests with the upper end of the container 54.

The cover defines a hole, provided to insert a stopper. The stopper is made from the same material as the cover.

At the end of the step for closing the container 120, the container 54 containing the mixture 122 comprising radioactive waste is closed as a parcel.

The mixture 122 solidifies, i.e., the mixture assumes a final form. In the described example, the mixture is fully solidified after a duration shorter than or equal to 29 days after the end of the vibrating step 16. After complete solidification of the mixture 122, the mixture 122 has a compression resistance comprised between 8 MPa and 35 MPa.

The stopper is inserted in the cover after the solidification duration of the mixture. The parcel is able to be stored.

Furthermore, the device for encapsulating radioactive waste 10 is washed regularly. For all that, the entire encapsulating device 10 is not fully washed at one time.

In the described example, a step for washing the transfer member 22 and the vat 26 of the mixer 12 takes place at the end of each encapsulating method. There is mixture residue 122 in contact with the transfer surface 84 of the transfer member 22 and/or in the inner volume 35 [of ] the vat 26 of the mixer 12.

At the beginning of the washing step, the cleaning member 32 of the mixer 12 and the washing device of the transfer surface 84 are activated.

First, the inner volume 35 of the vat 26 and the transfer surface 84 are splashed with filled water.

The filled water is a water densified by solid fillers, in particular fillers obtained by sand and/or clinker washing.

Second, the inner volume 35 of the vat 26 and the transfer surface 84 are rinsed with clean water.

In the continuation of the washing step, the cleaning member 32 of the mixer 12 and the washing device of the transfer surface 84 are still activated. The inner volume 35 of the vat 26 and the transfer surface 84 are splashed with high-pressure clean water, the pressure being comprised between 10 and 20 MPa.

All of the waters used during the washing step are collected and treated.

At the end of the washing step, the quantity of residue in contact with the vat 26 of the mixer 12 and the transfer surface 84 has decreased. The ratio of the residue mass after the washing step to the residue mass before the washing step is comprised between 0.001 and 0.01.

During the method for encapsulating radioactive waste previously described, the quantities of radioactive waste, binder, water and any additives are predetermined.

One technique for determining a possible combination of radioactive waste, binder, water and any additives of the mixture 122 is to characterize the behavior of the transfer member 22, in particular relative to the step 112 for transferring the mixture from the mixer 12 to the encapsulating unit 20.

A step for characterizing the behavior of the transfer member 22 will now be described in light of FIG. 4.

To characterize the behavior of the transfer member 22, the characterizing step implements the transfer surface 84 or a surface modeling the transfer surface 84. The surface modeling the transfer surface 84 has the same structure and the same composition. Subsequently, the surface used during the characterizing step in all of the aforementioned cases is called “transfer surface 84”.

The step for characterizing the behavior of the transfer member comprises the following steps:
a step for producing a test sample 130,
a detection step 132,
a moistening step 134,
a characterizing step 136,
an observation step 138,
a percussion and/or vibrating step 140, and
a selection step 142.

The step for producing a test sample 130 consists of producing a test sample having a composition representative of a possible mixture in the context of the method for encapsulating radioactive waste.

The test sample comprises dry radioactive waste, water and a binder.

In one embodiment, the test sample comprises at least one chemical additive. The chemical additive is for example a plasticizer, making it possible to increase the flow of the test sample on the transfer surface.

The dry radioactive waste, the water, the binder and any additive(s) are mixed so as to form a mixture.

In the described example, the radioactive waste of the test sample is a mixture of clinker and ash. The weight percentage of clinker is comprised between 0.7 and 0.8.

The test sample has a weight ratio of radioactive waste to binder comprised between 2.5 and 3, and more particularly equal to 2.75.

The test sample has a weight ratio of water to binder comprised between 0.77 and 0.97.

More particularly, in the case where the weight ratio of clinker is comprised between 0.7 and 0.75, and more particularly equal to 0.7, then the weight ratio of water to binder is comprised between 0.87 and 0.97.

In the case where the weight ratio of clinker is comprised between 0.75 and 0.8, and more particularly equal to 0.8, then the weight ratio of water to binder is comprised between 0.77 and 0.90.

The test sample has a water content level comprised between 10 and 35 liters per cubic meter. If the mixture has a satisfactory plastic behavior, the water content is reduced with monitoring of the hygrometry of the mixture.

The water in particular serves to hydrate the radioactive waste and insert additive. However, the increased water content causes undesirable effects in terms of the compression strength of the test sample after solidification thereof. The water content is therefore an important indicator to monitor, in particular using a sensor monitoring the hygrometry of the mixture 122.

At the end of the step for producing the test sample, a test sample as described below is produced.

Alternatively, several test samples with varied compositions or a same composition are made at the same time.

In one embodiment, the detection step 132 consists of detecting setting inhibitors, for example zinc, in the test sample.

Zinc is a setting inhibitor, i.e., zinc is able to delay the solidification of the mixture.

A setting inhibitor also decreases the internal bonds of the mixture. The presence of inhibitor in the mixture causes a loss of compression strength of the mixture after solidification of the mixture.

When a setting inhibitor is detected, the water content of the mixture is decreased.

The moistening step 134 consists of moistening the transfer surface 84.

Moistening for example consists of contributing, on the transfer surface 84, a water mass comprised between 100 g and 200 g for 1 m² of transfer surface 84.

The moistening of the transfer surface in particular improves the flow of the test sample on the transfer surface 84.

After the moistening step 134, the transfer surface 84 is moistened.

The characterizing step 136 consists of characterizing the adherence and/or the flow of the test sample on the transfer surface 84.

At the beginning of the characterizing step 136, the transfer surface 84 is moistened and the test sample is produced. The characterizing step 136 takes place after the steps for producing a test sample 130 and moistening 134.

The transfer surface 84 is at a temperature comprised between 15° C. and 30° C.

The pressure near the transfer surface 84 is comprised between 450 hPa and 1013.25 hPa.

The test sample is also in contact with a gas, for example air. The gas has a relative humidity comprised between 10 and 65%.

The gravity is equal to the Earth's gravity.

During the characterizing step 136, the test sample is placed in contact with the transfer surface 84.

The test sample is placed in contact with the transfer surface 84 in a single step.

In one embodiment, the test sample is subject to a freefall by a distance greater than or equal to 200 mm before reaching the transfer surface 84.

To characterize the adherence of the test sample on the transfer surface 84, a given quantity of test sample is placed in contact with the transfer surface 84.

The quantity of test sample placed in contact with the transfer surface for example has a mass greater than 20 grams for 100 m² of transfer surface 84, and more particularly a mass greater than 200 grams for 100 cm² of transfer surface 84.

In parallel with the characterizing step 136, an observation step 138 takes place. The observation step 138 consists of monitoring the presence or absence of a flow of the test sample on the transfer surface 84.

The presence or absence of a flow of the test sample on the transfer surface 84 is detected by measuring a mass of the material on the transfer surface 84. When the mass decreases, a flow of the test sample on the transfer surface is observed. When the mass is constant, there is no presence of a flow of test sample on the transfer surface.

Alternatively, the presence or absence of a flow of the test sample on the transfer surface 84 is monitored by an operator or by a computer through image analysis.

When there is no flow of the test sample on the transfer surface 84, part of the test sample remains in contact with the transfer surface 84. The part of the test sample remaining in contact with the transfer surface 84 is residue. The residue is recovered. The mass of the residue is calculated.

The higher the mass of the residue is, the more it is considered that the adherence of the test sample on the transfer surface 84 is significant.

To characterize the flow of the test sample on the transfer surface 84, a duration representative of the flow of the test sample is measured.

The representative duration is for example the time taken by the sample to travel one meter.

Two references are placed on the contact surface 84. The two references are placed lower than the entire part of the contact surface 84 with which the test sample is placed in contact. The references are substantially perpendicular to the axis connecting the two ends of the transfer member. The references traverse the transfer member in a direction. The references are parallel. The references are spaced apart by one meter.

In the described example, the measurements are done relative to the leading edge of the test sample, the leading edge of the sample being a part of the test sample that passes the reference first. During the flow of the test sample, the leading edge of the test sample may vary within the test sample.

The references are for example detectors. When a material passage is observed by a first reference, a stopwatch set to zero is started. When a material passage is observed by the second reference, the stopwatch is stopped.

If the test sample does not reach one of the references in a predetermined length of time, it is then considered that the test sample has a zero flow on the transfer surface 84.

Alternatively, the step comprises measuring a duration of the flow over a distance different from one meter. The representative duration is then the duration of the flow divided by the distance expressed in meters.

The less time the test sample takes to travel one meter, the more it is considered that the flow of the test sample over the transfer surface 84 is significant.

An anticipated flow rate of the mixture is calculated from the distance between the two references, the mass of the sample and the characteristic flow time.

Alternatively, only the flow or the adherence is characterized.

At the end of the characterizing step 136, the mass of test sample residue and/or the speed representative of the flow of the test sample are known.

The percussion and/or mechanical vibration step 140 consists of striking and/or vibrating the transfer surface 84. The percussion and/or mechanical vibration step 140 in particular increases the flow capacities and decreases the adherence of the test sample on the transfer surface 84.

Before the percussion and/or mechanical vibration step 140, the step for producing the test sample has been carried out.

The percussion and/or mechanical vibration step 140 begins before or at the same time as the test sample is placed in contact with the transfer surface.

At the beginning of the percussion and/or mechanical vibration step 140, the vibrating member 90 and/or the percussion system 92 are activated.

The vibrating member 90 causes the mechanical vibration of the transfer surface 84. In the described example, the vibrating member 90 oscillates at a frequency of less than or equal to 3000 Hz. The amplitude of the vibration is less than or equal to 100 mm.

In the described example, the transfer surface 84 is struck by the percussion system 92 at regular intervals. The frequency of the strikes is less than or equal to 3000 Hz. Upon each strike, the transfer surface 84 is moved by a distance comprised between 5 mm and 30 mm in the location where the transfer surface 84 is struck by the percussion system 92.

When the presence of flow is not or no longer observed, the vibrating member 90 and/or the percussion system 92 are deactivated.

At the end of the percussion and/or mechanical vibration step 140, the flow of the test sample on the transfer surface 84 is complete.

In one embodiment, all of the steps described above are repeated a predetermined number of times.

The selection step 142 consists of selecting one or several test samples fulfilling one or several criteria.

In the described example, the given criteria are the following:
the test sample residue mass during the characterizing step 136 is below 10 grams per 100 cm² of transfer surface, or more particularly below 7 grams for 100 cm² of transfer surface,
the duration representative of the flow is below 200 seconds, and
the anticipated flow rate equivalent to the displacement of at least 100 mm with a mass greater than 50 kg of mixture 122 per hour.

Alternatively, the test sample is selected if it fulfills only one of the preceding criteria.

At the end of the selection step 142, the test sample(s) are differentiated based on given criteria.

If no test sample fulfills the criteria and is selected in the selection step 142, the steps are started again from the step 130 for producing a test sample.

The step for characterizing the behavior of the transfer member makes it possible to select a mixture composition in the context of a method for encapsulating radioactive waste. The flow and/or adherence criteria in particular leverage the fact that a majority of the mixture reaches the encapsulating unit 20 from the mixer 12 in a reasonable amount of time. The adherence criteria also accounts for mixing residue on the transfer surface 84 after the transfer step 112 between the mixer 12 and the encapsulating unit 20. By decreasing the adherence of the mixture to the transfer surface, the washing of the transfer surface 84 is facilitated and the quantity of rinsing water used is decreased.

The method for encapsulating radioactive waste with a mixture having a composition similar to one of the test samples fulfilling the given criteria is implemented. A similar composition is a composition having the same weight percentages as the test sample to within 2%.

Alternatively, the device 10 does not comprise a water intake 18 and one or several separate additive intakes 24. The device 10 comprises a water and additive(s) intake comprising two ends. The water and additive(s) intake is connected at a first end to the mixer 12. The water and additive(s) intake is connected at a second end to a mixing vat.

The mixing vat comprises an outlet, a water intake and optionally additive intakes. The outlet has a retaining system, having at least two positions: an open position, to allow the water and additive to leave the mixing vat, and a closed position, to prevent the water and additive from leaving the mixing vat. The number of intakes is equal to one plus the number of additives. Each intake makes it possible to meter the quantity of water or additive poured into the mixing vat.

The encapsulating method is the same as before, with the exception of the steps for conveying water 106 and conveying additive 108.

The steps for conveying water 106 and conveying additive 108 are replaced by a step for conveying liquid. The retaining system of the mixing vat is in a closed position. The water and any additives are poured into the mixing vat in predetermined quantities through the intakes of the mixing vat. Then, the retaining system of the mixing vat is placed in an open position. The water and any additives are poured into the vat 26 of the mixer 12.

The characterizing step is the same as before.

The method for encapsulating radioactive waste comprises the following steps:
producing at least one test sample comprising dry radioactive waste, water and a binder,
characterizing the adherence and/or flow of the test sample on a transfer surface 84 of a transfer member 22,
selecting a composition of a mixture from the characterizing step,
mixing, in a mixer 12, dry radioactive waste, water and a binder in a mixer to form the mixture 122,
transferring the mixture 122 from the mixer 12 to an encapsulating unit 20, the mixture 122 being in contact with the transfer surface 84 of the transfer member 22.

1. A method for encapsulating radioactive waste, the method comprising the following steps:
mixing dry radioactive waste, water and a binder in a mixer to form a mixture,
transferring the mixture from the mixer to an encapsulating unit, the mixture being in contact with a transfer surface of a transfer member,
producing a test sample comprising dry radioactive waste, water and a binder, and
characterizing the adherence and/or flow of the test sample on the transfer surface.

2. The method according to claim 1, wherein the mixing and the production of the test sample are two separate steps.

3. The method according to claim 1, wherein the method further comprises a selection, the test sample being selected if the test sample fulfills one or more given criteria, a composition of the mixture being selected owing to the characterizing.

4. The method according to claim 3, wherein if no test sample is selected in the selection, the producing of a test sample and the characterizing of the adherence and/or flow of the test sample on the transfer surface are reiterated.

5. The method according to claim 3, wherein the given criteria are at least one of the following criteria:
a test sample residue mass during the characterizing is below 10 grams per 100 square centimeters (cm²) of transfer surface,
a duration representative of the flow is below 200 seconds, and
a flow rate equivalent to the displacement of at least 100 millimeters (mm) with a mass greater than 50 kilograms (kg) of mixture per hour.

6. The method according to claim 1, wherein the method further comprises vibrating the mixture using at least one vibrating needle having a main axis, the vibrating needle including a weight that is off-centered relative to the main axis rotating at a predetermined frequency.

7. The method according to claim 6, wherein, during the vibrating of the mixture, the predetermined frequency is comprised between 10,000 revolutions per minute and 20,000 revolutions per minute.

8. The method according to claim 6, wherein the method further comprises observing a release of air from the mixture, the vibrating of the mixture being stopped when a release of air from the mixture ceases to be observed.

9. The method according to claim 1, wherein the method further includes determining the density of the mixture.

10. The method according to claim 1, wherein one or several of the following characteristics is verified:
the transfer surface includes at least two layers, one of the layers being a coating made up of at least 95% natural rubber,
the transfer surface has a slope with an incline comprised between 8° and 20°,
the method further comprises percussion of the transfer surface,
the method further comprises mechanically vibrating the transfer surface, and
the method comprises moistening the transfer surface before the characterizing of the adherence and/or flow of the test sample on the transfer surface.

11. The method according to claim 1, wherein the method further comprises detecting the presence of setting inhibitors in the test sample.

12. The method according to claim 1, wherein the radioactive waste of the test sample consists of a mixture of clinker and ash, the weight percentage of clinker in the mixture being comprised between 0.7 and 0.8.

13. The method according to claim 1, wherein the test sample has at least one of the following features:
a water content level comprised between 10 and 35 liters per cubic meter (L·m⁻³),
a weight ratio of radioactive waste to binder comprised between 2.5 and 3, and
a weight ratio of water to binder comprised between 0.77 and 0.97.

14. The method according to claim 1, wherein the test sample further comprises a plasticizer.
